(19) United States
(12) Patent Application Publication
(10) Pub. No.: US 2013/0115374 A1
(43) Pub. Date: May 9, 2013

(54) POLYCRYSTALLINE SILICON PRODUCTION

(71) Applicants: Krishnakumar M. Jayakar, Butte, MT (US); Urban Robert Kultgen, II, Silver Bow, MT (US)

(72) Inventors: Krishnakumar M. Jayakar, Butte, MT (US); Urban Robert Kultgen, II, Silver Bow, MT (US)

(21) Appl. No.: 13/810,883

(22) PCT Filed: Jul. 19, 2011
(86) PCT No.: PCT/US2011/044573

§ 371 Date: Jan. 17, 2013

Related U.S. Application Data
(60) Provisional application No. 61/365,753, filed on Jul. 19, 2010.

(51) Int. Cl. C01B 33/035

(52) U.S. Cl. CPC C01B 33/035
USPC 427/255.18; 118/715

(57) ABSTRACT

A chemical vapor deposition (CVD) reactor system has a reaction chamber enclosed by a reaction chamber wall with an inner surface disposed towards the interior of the chamber. At least a portion of the wall is a heat control layer that faces the chamber and that consists of a material, such as electrolytic ally deposited nickel, that has an emissivity coefficient, as measured at 300K, of 0.1 or less and a hardness of at least 3.5 Moh. Polycrystalline silicon is produced from silicon-rich gases using such a CVD reactor system.

### CROSS REFERENCE TO RELATED APPLICATION

This claims the benefit of U.S. Provisional Application No. 61/365,753, filed Jul. 19, 2010, which is incorporated herein in its entirety.

### FIELD

The present disclosure relates to apparatus suitable for use in chemical vapor deposition reaction processes and having a reaction chamber with inner chamber surfaces with a heat control layer to reduce emissivity; and the use of the apparatus for the production of polycrystalline silicon.

### BACKGROUND

In the semiconductor industry it is common practice to produce high purity silicon by a process known as chemical vapor deposition (“CVD”). In brief, certain substances having silicon content are heated to high temperatures within a reaction chamber causing them to undergo decomposition, while in the vapor state, and produce elemental silicon. Depending on the design of the reaction chamber, and whether or not it additionally contains deposition surfaces, the elemental silicon may be collected as a powder or as a rod. Such silicon is frequently referred to as polysilicon or polycrystalline silicon.

One of the widely practiced conventional methods of polysilicon production is via deposition of polysilicon in a CVD reactor, and is generally identified as the Siemens method. In this method polysilicon is deposited, by decomposition of a silicon-containing gas such as for example trichlorosilane or monosilane, within the CVD reactor onto high-purity, electrically heated, thin silicon rods sometimes referred to as filaments. Silicon deposits on the filaments, thereby growing rods of larger diameter, while the rods are maintained at elevated temperatures, typically of 700 to 1100° C. To facilitate deposition of silicon on the growing rods and not on the reactor walls it is necessary to cool reactor walls and maintain their surface temperatures to levels below which deposition of silicon cannot occur to any appreciable extent, typically 450° C. or less.

The process of producing elemental silicon in this manner is energy intensive and over the past years there are have been many proposals relating to design of apparatus and modifications for the purpose of reducing overall energy consumption and managing heat loss from the reaction chamber. Significant amounts of energy are lost from the process by emission from the reaction chamber walls.

Consideration has already been given to use of reaction chamber walls modified to incorporate a low emissivity surface on the inner face of the reaction chamber wall. For example, and as reported by U.S. Pat. No. 4,173,944, the use of silver in the form of silver-plating as a coating inside a reaction chamber is known to reduce energy consumption. The patent publication GB 991,184 discloses the use of silver-plated steel for a similar purpose. However as silver tarnishes, it imposes additional maintenance and refinishing needs to keep equipment up and in working order. Also, silver is a relatively soft metal and susceptible to mechanical abrasion during maintenance routines or damage if touched by polysilicon rods during their removal from the chamber. In order to mitigate the issues associated with tarnishing and the maintenance and as alternative to silver, gold has been proposed as a modifying means to the CVD reaction chamber. For exemplary teachings relating to the use of gold in association with CVD processes and equipment the reader is referred to the following publications U.S. Pat. No. 4,579,080; U.S. Pat. No. 4,938,815; WO2009120859; JP59111997 and JP1208312. While use of gold is able to address some of the shortcomings of silver it is also a relatively soft material hence and suffers from similar mechanical disadvantages. There are also some concerns that gold may be susceptible to contaminating the elemental silicon and diminishing its end use value. Other past proposals have included the use of polished steel such as disclosed by the patent publication EP90321A.

In the solar industry, and especially the electronic industry, the purity of silicon is extremely important and contamination levels of other elements and metals at even very low parts per billion (ppb) amounts can be detrimental to the value of the product and necessitate additional post cleaning or purification procedures. Accordingly, it is desirable to provide an apparatus suitable for use as a CVD reactor, especially when preparing ultra high purity silicon, which reduces heat loss in a manner to provide acceptable energy consumption while providing improved mechanical damage resistance and at the same time mitigating risk for contamination of the deposited material.

### SUMMARY

As described herein, the inner walls of a chemical vapor deposition reaction chamber advantageously are coated with a substance having certain useful emissivity and hardness properties.

In a first aspect, a chemical vapor deposition reactor system has a reaction chamber enclosed by a reaction chamber wall with an outer and inner surface wherein the inner surface is disposed towards the interior of the chamber and of which at least a portion of the inner wall a heat control layer characterized in that the heat control layer is a relatively pure substance that has:
i) an emissivity coefficient, as measured at 300K, of 0.1 or less; and
ii) a hardness of at least 3.5 Moh.

In another aspect, a chemical vapor deposition reactor system has a reaction chamber enclosed by a reaction chamber wall with an outer and inner surface wherein the inner surface is disposed towards the interior of the chamber and in which at least a portion of the inner wall is a heat control layer characterized in that the heat control layer has an average thickness of from 0.1 to 10 microns and is electroplated nickel.

In yet another aspect, a method for deposition of elemental silicon comprises subjecting within, a chemical vapor deposition reactor system, a silicon-containing substance in a gaseous state to temperature sufficient to effect its decomposition wherein the reactor system contains a reaction chamber as described in the preceding aspects.

### BRIEF DESCRIPTION OF THE DRAWING

FIG. 1 is a side elevation of a reactor shown partly in section.

### DETAILED DESCRIPTION

A chemical vapor deposition apparatus, or reactor, typically comprises a reaction chamber defined by reaction chamber walls having an outer surface and an inner surface the latter disposed towards a cavity or interior space of the chamber. The reactor is typically equipped with a gas inlet nozzle, and a gas outlet nozzle to permit the passage of gas, or gas mixtures, through the chamber at or above atmospheric pressure. In some instances the reaction chamber may be open with entry and exit apertures, analogous to an open tube, and in other instances it will be fully enclosed and sealed through attachment of a base plate. To effect the reaction or chemical decomposition of the gas(es) passed through the chamber a heat source is necessary, this is typically provided for by the use of electrical current passing through one or more filaments positioned and held in a fixed spatial placement within the reaction chamber. Further the apparatus may also be equipped with a cooling system for controlling the temperature within the chamber or the reaction chamber walls.

The subject of this disclosure is the provision of at least a portion of the reaction chamber wall and specifically the provision of the inner surface as disposed towards the cavity of the reaction chamber with a heat control layer. For the purpose of this disclosure, if the apparatus comprises a base plate, the base plate is considered the equivalent of a reaction chamber wall. The heat control layer is characterized in that it is a relatively pure substance having an emissivity coefficient as measured at 300K of 0.1 or less, advantageously of 0.08 or less, and more advantageously of 0.05 or less. The heat control layer is further characterized by having a hardness of 3.5 Moh or more, advantageously 4.0 Moh or more, and yet more advantageously 5.0 Moh or more; advantageously the hardness does not exceed 8.0 Moh and advantageously does not exceed 7.0 Moh. In a particularly advantageous embodiment, the heat control layer has an emissivity coefficient of 0.1 or less in combination with a hardness of from 3.5 to 7.0 Moh; in a yet a more advantageous embodiment the heat control layer has an emissivity coefficient of 0.08 or less and a hardness of from 4.0 to 6.8 Moh.

The heat control layer should be present in an amount sufficient for its emissivity attribute to reduce the overall loss of energy (heat) from the apparatus and diminish energy consumption of the equipment, relative to equipment where such a heat control layer is absent. The heat control layer is present on at least a portion of the area of the inner surface of the reaction chamber wall; by portion it is understood at least 10% of the area, advantageously at least 30% of the area, and more advantageously at least 50% of the total surface area of the inner wall.

The emissivity properties of the heat control layer are not influenced by its thickness. The thickness of the heat control layer will be at least 0.1 micron, advantageously at least 0.5 micron, and more advantageously at least 5.0 micron, and yet more advantageously at least 10 micron. The thickness will be up to 100 microns, advantageously up to 75 microns, and more advantageously up to 50 microns. In a highly advantageous embodiment the heat control layer will be present in an amount of at least 30% of the total surface area of the reaction chamber inner wall(s), and in an average thickness ranging from 0.5 to 75 microns, and advantageously from 5 to 75 microns.

The heat control layer is typically a relatively pure substance and generally a metal. By “relatively pure” it is understood as being a substance having an elemental purity of at least 75% or greater, advantageously at least 90% or greater, and more advantageously at least 99% or greater. The heat control layer must also be able to withstand the operational temperatures of the CVD reactor without compromise to its integrity thus desirably when a metal it will have a melting point above the operational temperature of the CVD reactor.

Metal substances suitable for deployment as the heat control layer are exemplified by vanadium, tantalum, nickel, platinum, chromium, molybdenum and alloys or mixtures of two or more of such metals. Nickel is considered especially suitable for use as the heat control layer as in addition to its desirable emissivity and hardness attributes it also offers good chemical resistance to materials such as for example chemical agents which may be used when cleaning CVD reactors between operational uses.

In the instance when CVD reactors are used to manufacture polycrystalline silicon from silicon-rich gases such as, for example, trichlorosilane, or monosilane (SiH₄) then purity of the resulting silicon is extremely important and it is highly desirable to avoid risk of contamination by trace amounts of other elements. In these operations it is typical for the bulk of the reactor walls to be made up of steel comprising chromium and or nickel (up to 20%). Accordingly to avoid introduction of other elemental contaminant sources when producing polycrystalline silicon advantageously the heat control layer substance is one as already present in the elemental finger print of the apparatus, in this instance that is chromium or especially nickel.

The heat control layer may be provided by any of the procedures known to a person skilled in the art of metallurgy, metal plating or metal coating techniques.

In the example when nickel is the heat control layer this may be achieved by electroplating methods or by non-electroplating, chemical, methods including electroless plating and brush plating. Nickel plated onto a surface such as steel, either directly or indirectly over a copper adhesive layer, by electrolytic deposition is known to have especially low emissivity coefficients. Accordingly in an advantageous embodiment the heat control layer is electrolytically deposited nickel, or as otherwise referred to electroplated nickel.

The emissivity coefficients and hardness for a number of substances, as reported in the open literature, are given in Table 1.

| | Melting Point | Hardness | |
|---|---|---|---|
| Substance | (° C.) | (Moh) | Emissivity Coefficient |
| Vanadium | 1910 | 6.7 | 0.1 |
| Nickel | 1453 | 4.0 | 0.07 polished |
| | | | 0.04 electrolytic |
| Tantalum | 3017 | 6.5 | 0.1 |
| Chromium | 1907 | 8.5 | 0.06 polished |
| Platinum | 1768 | 4.0 | 0.05 polished |
| Molybdenum | 2623 | 5.5 | 0.07 polished |

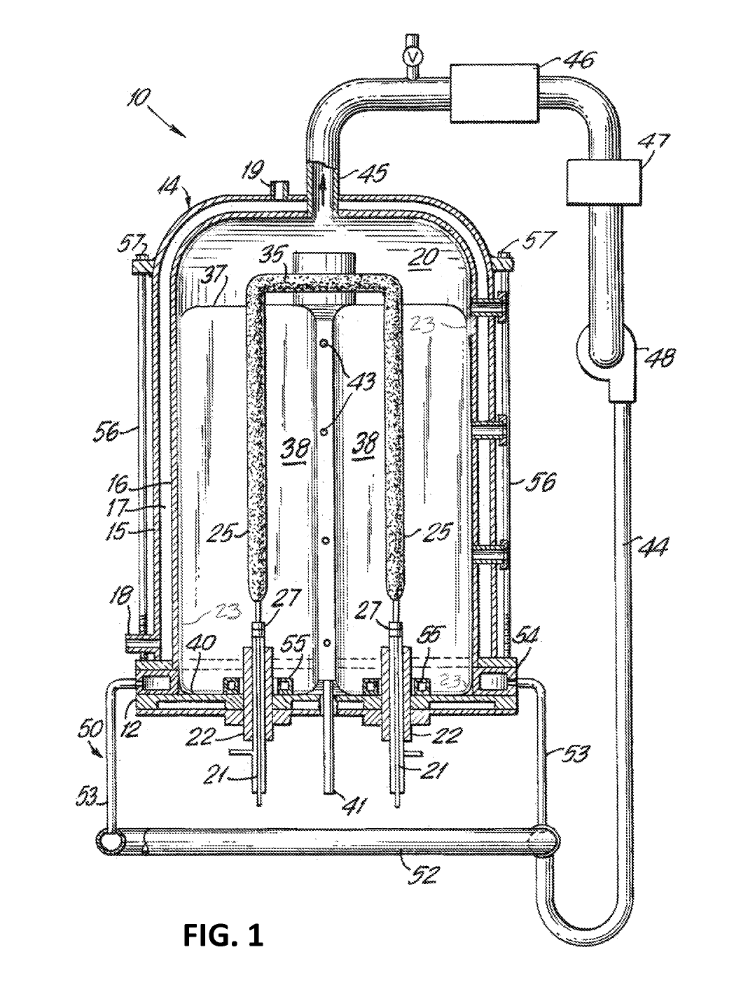

As an example, CVD reactor 10 has an elliptical cross sectional geometry as shown in FIG. 1 and comprises a base member 12 upon which is mounted a shell 14 having a bell jar configuration with a double wall construction defined by an outer wall 15 and an inner wall 16 that has an inner surface defining a reaction chamber 20. The reaction chamber 20 is configured to contain a pyrolysis and silicon deposition operation. A portion of the wall 16 is a heat control layer 23 that faces the chamber 20.

The outer and inner walls 15, 16 are spaced apart from each other to form a clearance space 17. A coolant such as water is passed through an inlet port 18 in wall 15 into the clearance space 17 and exits from an exit port 19.

Electrodes 21 are provided at the bottom of the chamber 20. Each electrode 21 is vertically mounted in a thermal shield 22 affixed to the base member 12. A silicon starter filament 25 is mounted upon each electrode 21 so that the filament is held in a fixed special placement within the chamber 20. The array of electrodes 21 should consist of an even number connected to a corresponding even number of starter filaments 25. Each silicon starter filament 25 is spaced a substantially equal distance apart and is radially separated from the inner wall 17 of the cover 14 by a substantially equal distance.

Each of the electrodes 21 extend below the base member 12 where each is connected to a conventional AC source of power (not shown). A disposable carbon chuck 27 is mounted on the upper end of each electrode 21 in contact with each starter filament 25. The carbon chuck 27 simplifies the removal of the finished silicon rods from the reactor 10 after the pyrolysis operation is complete. The silicon filaments 25 are also held in a substantially vertical orientation relative to the base member 12.

An electric circuit is completed between each set of two silicon filaments 25 through a connector 35 preferably of the same composition as the filaments 25. The silicon filaments 25 are preferably formed in pairs with each pair having a horseshoe-like configuration with the bridging section representing the connector 35. In this way each horseshoe-like pair of filaments 25 complete an electric circuit through the electrodes 21 in which the rods 25 are mounted. A high purity uniform deposit of polycrystalline silicon is formed on each upright silicon filament 25.

A thermal insulator 37 is mounted upon the base member 12 to provide thermal insulation for each filament in a conventional fashion. The thermal insulator 37 is also used as a means for controlling the flow of recycle gas around each filament. The thermal insulator 37 is vertically mounted upon or supported by the base member 12 and includes partitioning walls 38 which extend on opposite sides of each starter filament 25 to form an elongated chamber 40 substantially surrounding each filament 25. The chambers 40 operate to guide the distribution of recycled gas uniformly around each filament 25. The filament 25 preferably lies in the symmetrical center of each chamber 40. The partitioning walls 38 may be mounted directly upon the base member 12 or mounted relatively close thereto and extend vertically up as close as possible to the connector 35 bridging the silicon filaments 25.

A silicon-containing substance, particularly monosilane gas, is introduced into the reactor 10 through a supply pipe 41 which extends through the base member 12 and the core of the thermal insulator 37 to a plurality of outlets 43. Alternatively, the monosilane gas can be introduced into the recycle gas supply pipe 44 before it reenters the reactor 10. Conditions are maintained within the reaction chamber 20 such that decomposition of the monosilane gas produces elemental silicon that deposits onto the filaments and results in the formation of polycrystalline silicon rods having diameters greater than the diameters of the filaments. In particular the monosilane gas is subjected to a temperature sufficient to effect decomposition of monosilane gas and deposition of elemental silicon.

Exhaust gas is withdrawn from the reactor 10 through an exit port 45. The exhaust gas is fed past a heat exchanger 46, a filter 47 and into a blower 48 whereupon it is recycled back through the supply pipe 44 into the reactor 10 at a controlled flow rate. A valve V is connected in the exhaust line preferably adjacent the exit port 45 to allow a portion of the exhaust gases to be vented to provide for the recovery of silane and removal of excess hydrogen formed by the decomposition of silane. The heat exchanger 46 serves to cool the exhaust gases so as to control the reentry temperature into the reactor 10. The filter 47 serves to remove entrained silicon powder present in the exhaust gases. The heat exchanger 46, filter 47 and blower 48 are all conventional equipment.

The recycled exhaust gases are driven by the blower 48 through a distribution network 50 into the reactor 10. The distribution network 50 distributes the recycled gas in a controlled manner to cause uniform growth of the polycrystalline silicon. The distribution network 50 includes a manifold 52, feeder lines 53, a secondary manifold 54 and a plurality of distribution rings 55. The manifold 54 is mounted upon the base member 12. The shell 14 is seated upon the manifold 54 and includes a plurality of ear like ribs 56 projecting from the shell 14 with mounting screws 57 extending therethrough for attaching the shell 14 to the base member 12.

Operation of the illustrated reactor 10 discussed herein, is an illustrative example in reference to the deposition of silicon by the decomposition of silane (SiH₄). Analogous apparatus and methods can be used for other known silicon-containing substances (precursor gasses) such as polysilanes (SiₙH₂ₙ₊₂), chlorosilanes, bromosilanes, and iodosilanes, for example, disilane (Si₂H₆), dichlorosilane (SiH₂Cl₂), trichlorosilane (SiHCl₃), silicon tetrachloride (SiCl₄), dibromosilane (SiH₂Br₂), tribromosilane (SiHBr₃), silicon tetrabromide (SiBr₄), diiodosilane (SiH₂I₂), triiodosilane (SiHI₃), silicon tetraiodide (SiBr₄), and mixtures thereof.

In some reactors, the product silicon is in the form of a powder obtained by maintaining conditions within the reaction chamber such that decomposition of the silicon-containing substance produces elemental silicon in the form of silicon powder. For the purpose of this disclosure, silicon powder is a high purity silicon having a maximum cross-sectional dimension (diameter) of 15 μm or less.

The subject invention can achieve benefits such as increased power savings, reduced operating temperatures, reduced maintenance costs and mitigate risk of contamination.

Although the subject invention has been described with respect to advantageous examples, those skilled in the art will readily appreciate that changes or modifications thereto may be made without departing from the spirit or scope of the subject invention as defined by the appended claims. In view of the many possible embodiments to which the principles of the disclosed processes may be applied, it should be recognized that the teachings herein are only examples and should not be taken as limiting the scope of the invention.

We claim:

1. A chemical vapor deposition reactor system comprising a wall having an inner surface that defines a reaction chamber, a portion of the wall being a heat control layer facing the chamber, the heat control layer consisting of a substance that has an emissivity coefficient, as measured at 300K, of not more than 0.1 and that has a hardness of at least 3.5 Moh.

2. The reactor system of claim 1 wherein the thickness of the heat control layer is not more than 100 microns.

3. The reactor system of claim 1 wherein the heat control layer has an emissivity coefficient of not more than 0.05.

4. The reactor system of claim 1 wherein the heat control layer is a coating of a substance selected from the group consisting of tungsten, tantalum, nickel, platinum, chromium, and molybdenum.

5. The reactor system of claim 4 wherein the heat control layer is nickel.

6. The reactor system of claim 5 wherein the nickel is electroplated nickel.

7. The reactor system of claim 4 wherein the heat control layer consists of a substance that is relatively pure.

8. A chemical vapor deposition reactor system comprising a wall having an inner surface that defines a reaction chamber, a portion of the wall being a heat control layer facing the chamber, the heat control layer being electroplated nickel and having an average thickness of from 5 to 75 microns.

9. The reactor system of claim 8 wherein the heat control layer is consists of electroplated nickel that is relatively pure.

10. A method for deposition of elemental silicon which comprises subjecting, within the reaction chamber of a reactor system according to claim 1, a silicon-containing substance in a gaseous state to a temperature sufficient to effect decomposition of the silicon-containing substance.

11. The method of claim 10 further comprising:
positioning and holding at least one filament in a fixed spatial placement within the reaction chamber; and
maintaining conditions within the reaction chamber such that decomposition of the silicon-containing substance produces elemental silicon that deposits onto the least one filament and results in the formation of at least one polycrystalline silicon rod having a diameter greater than the diameter of the filament.

12. The method of claim 10 further comprising maintaining conditions within the reaction chamber such that decomposition of the silicon-containing substance produces elemental silicon in the form of silicon powder.

13. A method for deposition of elemental silicon which comprises subjecting, within the reaction chamber of a reactor system according to claim 8, a silicon-containing substance in a gaseous state to a temperature sufficient to effect decomposition of the silicon-containing substance.

14. The method of claim 13 further comprising:
positioning and holding at least one filament in a fixed spatial placement within the reaction chamber; and
maintaining conditions within the reaction chamber such that decomposition of the silicon-containing substance produces elemental silicon that deposits onto the least one filament and results in the formation of at least one polycrystalline silicon rod having a diameter greater than the diameter of the filament.

15. The method of claim 13 further comprising maintaining conditions within the reaction chamber such that decomposition of the silicon-containing substance produces elemental silicon in the form of silicon powder.
